(19) United States
(12) Patent Application Publication
(10) Pub. No.: US 2019/0149804 A1
(43) Pub. Date: May 16, 2019

(54) ENHANCED THREE DIMENSIONAL IMAGING BY FOCUS CONTROLLED ILLUMINATION

(71) Applicants: JIN YOUNG SOHN, FULLERTON, CA (US); GYOUNG IL CHO, FULLERTON, CA (US); CHEONG SOO SEO, BREA, CA (US)

(72) Inventors: JIN YOUNG SOHN, FULLERTON, CA (US); GYOUNG IL CHO, FULLERTON, CA (US); CHEONG SOO SEO, BREA, CA (US)

(73) Assignee: STEREO DISPLAY, INC., ANAHEIM, CA (US)

(21) Appl. No.: 15/813,148

(22) Filed: Nov. 14, 2017

(51) Int. Cl. H04N 13/254; G03B 15/03

(52) U.S. Cl. CPC H04N 13/254; G03B 15/03

(57) ABSTRACT

The present invention comprises focus controlled illumination and variable focus optical element. With focus controlled illumination, contrast of the image improves. While reconstructing the three dimensional image with taken data, contrast of the image is very important. Also the contrast of the images is important for the quality of the images. By using focus controlled illumination, surfaces without texture, mirror-like surface, inclined surface can be imaged with this technique and apparatus.

### FIELD OF THE INVENTION

The present invention relates to general three dimensional imaging system and more specifically three dimensional imaging from optical depth.

### BACKGROUND OF THE INVENTION

Three dimensional imaging and display technologies are long studied technology since twentieth century. There are so many different three dimensional imaging systems as well as so many different ways to represent an object in three dimensional space. The most popular three dimensional imaging system is using stereoscopic imaging technique which acquires depth information from a scene in the form that the parallax phenomenon of human eyes is simulated. When human eyes see a scene, right and left side eyes have two different perspectives due to their separation. The brain fuses these two perspectives and assesses the visual depth Like human eyes do, stereoscopic three dimensional imaging systems take two perspective images by two cameras that are disposed to view the scene from different angles at the same time as disclosed in U.S. Pat. No. 5,432,712 to Chan. These devices, however, tend to be large and heavy, and come at high cost due to multiple camera systems and their optical axis separation requirement. Also, when stereoscopic images are displayed for three-dimensional viewing, many technical problems can be arisen involved with arbitrary distribution of the viewer's position, watching by multiple viewers, binocular disparity due to deviations in the distance between the two eyes, vergence, fatigue accumulation in the eye, accommodation, the relative position change of the three-dimensional image due to viewer's movement, etc. More recently, U.S. Pat. No. 9,494,418 to Schmidt relates the baseline of indicating means of triangulation which is scanned by a form of multiple monitoring beams followed by reflected illuminating beam from the object with change of the view point. This monitoring beam from the multiple viewpoints determines distance between the light source and the imaging sensor using parallax between one monitoring beam from one viewpoint and the other beam from the different viewpoint. Further using software algorithm technique of the triangulation method and stitching method, the object can be imaged with multiple images from multiple viewpoints. Also this algorithm can further implement compensation or coupled operation of the light source luminous intensity dependency. Besides the abovementioned patents, many technologies are based on this stereoscopic or triangulation method for three dimensional imaging. These techniques usually suffer dissimilarity of the images between two images from different camera angle. Light intensity compensation or coupled operation of light and image sensor solve a little bit of this disadvantage, but still has issues to hinder the usage of this technique.

In FIG. 1 (prior art), schematic stereoscopic imaging configuration is shown. Two cameras 11, 12 are located to view same object 13 in the figure. Each camera forms image corresponding imaginary image planes 14, 15. Camera 11 from left forms an image plane 14 for left hand side image and camera 12 from right forms another image plane 15 for right hand side image. For a single object point P, each image plane has the corresponding point. Left hand side image plane 14 has corresponding point 16 U_{left}. And the left camera 11 is located at left hand side camera L on the extended line PU_{left}. And the right hand side image plane 15 also forms another geometry of the object P, right hand side has corresponding point 17 U_{right}, right hand side camera R. Then one big triangle can be formed ΔLPR. By using known distance b between cameras, applying the triangulation method, distances from the camera along the lines LP or RP can be calculated.

U.S. Pat. No. 6,503,195 to Keller discloses a structured light depth extraction system in which a projector projects a structured light pattern such as grids in the visible or invisible form onto an object, and then an image processor calculates depth information based on the reflected light pattern. In case of using visible light, image quality can be degraded while using invisible light requires an additional sensor system. Also, performance of the structured light depth extraction system depends on the reflectivity of the object. A further and related study has been done in generating a three dimensional model of the object using the structured light digitizing operation. In U.S. Pat. No. 7,978,892 to Quadling, the disclosure also indicates specifically in the field of dental imaging technique in accordance with combination of photogrammetry and a structured light pattern digitizing method. By using photogrammetry and the projection of a patterned illumination onto the object can determine three dimensional coordinates for each matched pixel of the object measuring the distortion or dislocation of the patterned illumination. These techniques work great in certain field, but still there are some disadvantages such as requirements for extra illumination and alteration of the image due to uneven illumination. Still many effort has been being tried for improving this disadvantages.

In FIG. 2 (prior art), three dimensional imaging technique using structured light is shown. Illumination projector 21 projects a structured light 22 (structured illumination pattern). In this figure, stripe lines are used. When the stripe lines 22 are illuminated on a flat surface 23, all the lines should be parallel 24 to each other. When there is a bump 25, one or multiple lines are shifted 26 with height of the bump 25. Camera 27 takes image of the structured illumination pattern on the object. With these images, algorithm calculates the relation between illumination light, and the camera, three dimensional geometry thus finally can form a distance R from the object point P to the camera 27. When used with multiple structured light patterns, this technique is especially powerful. When the system uses quarter period illumination pattern, specially phase shift interferometric algorithm can be used for enhancing the resolution of the three dimensional imaging.

U.S. Pat. No. 3,506,327 to Leith discloses a holographic imaging system, which uses coherent radiation to produce an object-bearing beam and reference beam. These two beams produce a pattern of interference fringe on the detector, wherein the intensity and phase information of light is recorded. Three dimensional image can be reconstructed by illuminating the pattern of interference fringe with the reference beam. The maximum image depth is limited by mainly the coherence length of the beam. The holographic imaging system requires expensive and high power consuming coherent light source such as laser and the near darkroom conditions for imaging. Therefore, the holographic imaging system is not applicable to portable imaging devices as well as may cause some safety concerns using in the public area. Due to difficulties for illumination to holography, this holographic technique is not much commercialized even though it can give best information of the three dimensional object.

U.S. Pat. No. 5,032,720 to White and U.S. Pat. No. 6,949,069 to Farkas disclose a three dimensional confocal system in which a point of interest is illuminated by a light source using a pinhole aperture. The confocal system can provide a high resolution three dimensional image with a single camera system, but most of illuminating light is wasted and causes noise problem. To overcome this, U.S. Pat. No. 6,749,346 to Dickensheets and U.S. Pat. No. 6,563,105 to Seibel use a single optical fiber to scan and collect reflected light, but point by point scanning can lead to a slow image refresh rate. Due to complexity of the confocal system, package into small volume was a critical issue for this technique. U.S. Pat. No. 2010/0085636 by Berner discloses the compact configuration of the optical system by the confocal system, which is accomplished by using an aspherical movable lenses in the end location of the objective lens assembly. To use the general concept of confocal system, the object distance should be matched with image distance. In this disclosure, moving objective lenses play role for adjusting or matching object distance while maintaining image distance of the optical system thus maintaining confocal geometry. By extension, a configuration of the lenses is designed by means of an optimizing progress for optical lenses to the extent that a spot size for all spots in an image is minimized for all focal planes, in the ramification of sufficiency done for multiple spots in the image and at three different focal planes. A minimum spot size points obtained from optimizing optical lenses preferably applies to the image of the object with curved surface considering field curvature for each focal plane as an aspherical surface for calibration of the three dimensional imaging system. In an optical system for small objects such as intraoral dental scanning, these features work on the atmosphere of a proximal and distal portion as crucial factors.

In FIG. 3, schematic diagram of confocal system is shown. Usually an intense light source 31 such as a laser is used since there are pinholes which filters intensity of the light. And to improve image quality, often tunable filter 32 is used. Especially acousto-optic tunable filter (AOTF) 32 is used for fast time controlling for image taking speed. Then the illumination light pass through an illumination pinhole 33 and form a focal plane of illumination. The light passed through the illumination pinhole 33 then reflected from beam splitter 34. This beam splitter 34 redirects the illumination to the object 35 through the objective lens 36. The light passed through the illumination pinhole 33 forms exactly one focal plane 37 of the object 35. And the reflected light from the object 35 then passes another pinhole 38 (imaging pinhole) and finally arrives onto image sensor 39. Since only light with sharing focuses can pass through the pinholes 33, 38, only focused image of exact focal plane can be imaged onto the image sensor 39. For lateral image scanning, Nipkow disc or other scanning method can be introduced other than scanning beamsplitting mirror method. Vertically, the object 35 can be moved while maintaining the focal plane 37 of the system.

The depth from focus method is well known for three dimensional imaging, wherein a sequence of images is taken by changing the camera focus and in-focus regions are extracted from the images. Camera focus can be changed in many different ways. U.S. Pat. No. 5,986,811 to Wohlstadter discloses a three dimensional imaging method and system using conventional motorized optics having an input lens and an output lens to change the focal length of the imaging system. Conventional motorized optics has a slow response time and complex driving mechanism to control the relative position of the lenses. Therefore, it is difficult to use in the real-time imaging system and miniaturize the imaging system.

U.S. Pat. No. 6,344,930 to Kaneko discloses a total-focus imaging system using a sealed liquid lens actuated by a piezoelectric actuator to change the focal length of the imaging system. The proposed liquid lens has a slow focal length change speed of several Hz. The system can have only half a dozen of focal length changes for each three dimensional image when considering the standard video or movie rate. Besides, the lens has a small focal length variation range. These problems limit the possible range of depth and the depth resolution of the three dimensional image. A most advanced variable focal length lens is a liquid crystal variable focal length lens, wherein its focal length is changed by modulating the refractive index. However, it has a complex mechanism to control it and a slow response time typically on the order of hundreds of milliseconds, while the fastest response liquid crystal lens has a response time of tens of milliseconds, which still provides a low depth resolution three dimensional imaging. Also, liquid lens technology has a small focal length variation and a low focusing efficiency. A high speed, large variation of numerical aperture, and large diameter of variable focal length lens is necessary to get a real-time, large range of depth, and high depth resolution three dimensional image.

### SUMMARY OF THE INVENTION

The present invention contributes to enhance three dimensional imaging by using focus controlled illumination. For using focus control of the illumination and image, variable focus optical elements are used. To have a good three dimensional imaging system, high reliability and repeatability is required especially for the variable focus optical element. Thanks to its high reliability and repeatability with high speed, Micromirror Array Lens can be used as a variable focus optical element in the present invention.

In the present invention, an illumination light beam passes through the variable optical element then focus of the illumination is controlled to match with imaging system. The focus controlled illumination projected onto the object and the reflected light passes through the imaging optics. This focus control is coupled with the object focal plane of the object. While performing three dimensional imaging process, this object focal plane is scanned with variable focus optical element. After the imaging optics of imaging system, another variable focus optical element controls the focus of the image plane.

In the present invention, a variable focus optical element is introduced as a three-dimensional scanning device, especially depth wise scanning is obtaining through the variable focus optical element. Also this variable focus optical element is used for controlling illumination focus control. Since the focus of the illumination is controlled, data with higher contrast can be taken and with this high contrast images, depth information from depth from focus algorithm can be applied with high precision. Sometimes for surfaces without texture, inclined surfaces, or mirror like surfaces, depth from focus algorithm seldom gives a good depth information. The images of the focus controlled illumination itself can provide depth information of the object with high precision. With help of the high contrast image, the whole three dimensional imaging system can get high resolution of the depth information despite of texture, inclination, reflectance of the objects.

When a Micromirror Array Lens is used in the present invention, high speed imaging can be achieved thanks to the high speed of the Micromirror Array Lens. In three dimensional imaging, especially depth from focus technique, high speed imaging is critical since lots of images should be taken and calculated at the same time. Since three dimensional imaging is calculated from the multiple images of the object, reliability and repeatability is a must condition for a good three dimensional imaging system. Micromirror Array Lens can give this high reliability and repeatability.

When the Micromirror Array Lens is used as a variable focus optical element, it can generate high speed of depth scanning. The Micromirror Array Lens can generate reliable and repeatable focal scanning as well as high enough speed for the imaging speed. With the Micromirror Array Lens the main problem, speed of the three dimensional imaging system can be enhanced based on focus varying speed of the Micromirror Array Lens. The general principle and methods for making the Micromirror Array Lens are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,619,807 issued Nov. 17, 2009 to Baek, and U.S. Pat. No. 7,777,959 issued Aug. 17, 2010 to Sohn, all of which are incorporated herein by references. And the detail of the general properties of the Micromirror Array Lens are disclosed in U.S. Pat. No. 7,173,653 issued Feb. 6, 2007 to Gim, U.S. Pat. No. 7,215,882 issued May 8, 2007 to Cho, U.S. Pat. No. 7,236,289 issued Jun. 26, 2007 to Baek, U.S. Pat. No. 7,354,167 issued Apr. 8, 2008 to Cho, U.S. Pat. No. 9,565,340 issued Feb. 7, 20017 to Seo, U.S. Pat. No. 9,736,346 issued Aug. 15, 2017 to Baek, all of which are incorporated herein by references.

And the Micromirror Array Lens can generate more than order of magnitude longer length of the focal plane shift that by piezo electric transducer. Thus, the present invention with the Micromirror Array Lens can overcome short scanning range of the piezo-electric transducer driven three dimensional imaging system as well as low speed scanning limit of the three dimensional imaging system.

The present invention comprises an illumination source with focus control, an imaging optics wherein the imaging optics determines base optical power of the three dimensional imaging system, a variable focus optical element wherein the variable focus optical element changes focal plane of the imaging system, and a photosensitive optical sensor device wherein the optical sensor takes area images, wherein said variable focus optical element scans objects in optical depth dimension to get three dimensional images.

The present invention provides a high speed three dimensional scanning method. Since no macro-moving structure is used, vibration effect can be eliminated and thus good image quality with reliability can be obtained. Thanks to high scanning speed of the system, the present invention can be used in many industrial fields where three dimensional object images are essential.

When the Micromirror Array Lens is used as a variable focus optical element, it can generate high speed of depth scanning. The Micromirror Array Lens can generate reliable and repeatable focal scanning as well as high enough speed for the imaging speed. With the Micromirror Array Lens, the main problem of the low speed of the three dimensional imaging system can be enhanced based on focus varying speed of the Micromirror Array Lens. The general principle and methods for making the Micromirror Array Lens are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,619,807 issued Nov. 17, 2009 to Baek, and U.S. Pat. No. 7,777,959 issued Aug. 17, 2010 to Sohn, all of which are incorporated herein by references.

Moreover, the Micromirror Array Lens can generate more than order of magnitude longer length of the focal plane shift that that by piezo electric transducer, which is commonly used in the depth scan of the three dimensional microscope. Thus, the present invention with the Micromirror Array Lens can overcome short scanning range of the piezo-electric transducer driven three dimensional imaging system as well as low speed scanning limit of the three dimensional imaging system.

The present invention provides a high speed three dimensional scanning method. Since no macro-moving structure is used, vibration effect can be eliminated and thus good image quality with reliability can be obtained. Thanks to high scanning speed of the system, the present invention can be used in many industrial fields where three dimensional object images are essential.

Although the present invention is briefly summarized, the full understanding of the invention can be obtained by the following drawings, detailed descriptions, and appended claims.

### DESCRIPTION OF FIGURES

These and other features, aspects and advantages of the present invention will become better understood with reference to the accompanying drawings, wherein

FIG. 1 illustrates point scanning confocal microscopy system (prior art);

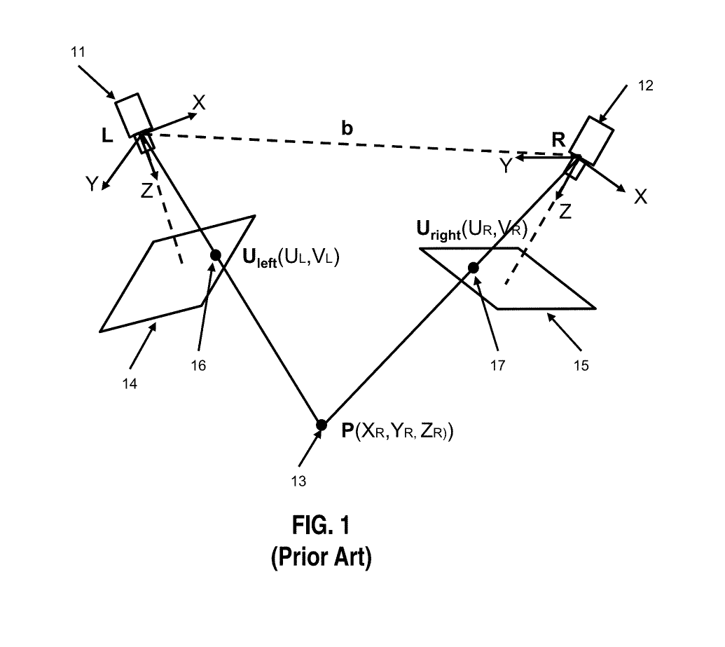

FIG. 2 illustrates line scanning confocal microscopy system (prior art);

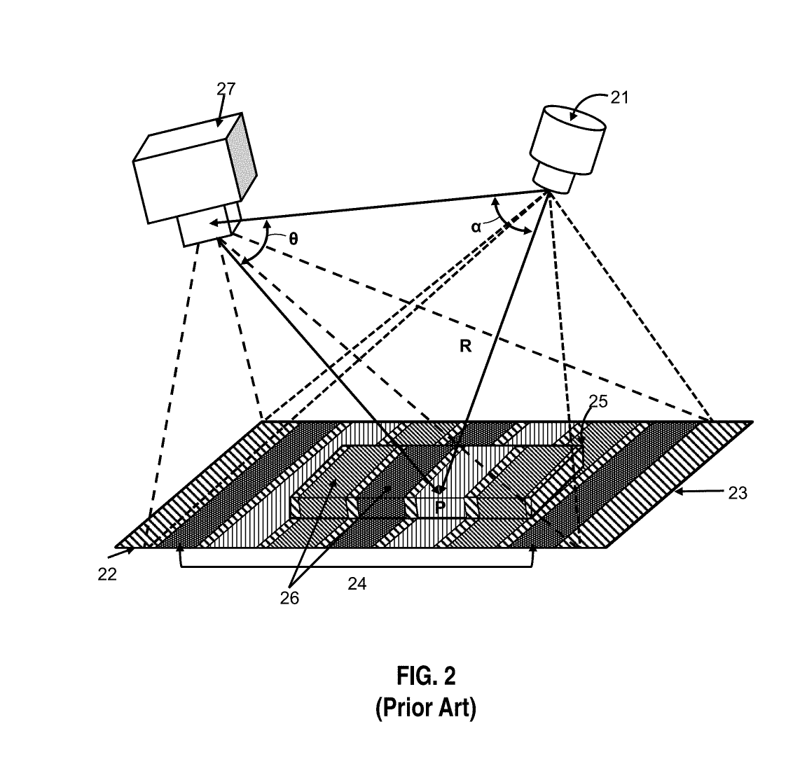

FIG. 3 illustrates scanning confocal microscopy system with rotating Nipkow disk (prior art);

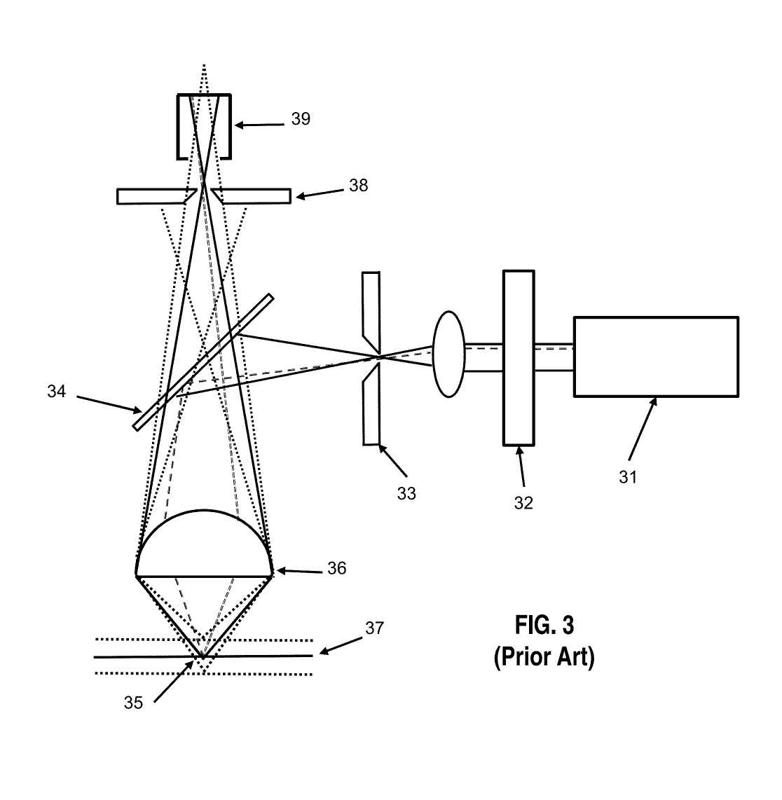

FIG. 4 shows schematic configuration of three dimensional imaging system with variable focus optical element (Micromirror Array Lens);

FIG. 5 shows schematic configuration of three dimensional imaging system with variable focus optical element (Micromirror Array Lens) including co-axial pattern generating illumination system;

FIG. 6 shows schematic configuration of three dimensional imaging system with variable focus optical element (Micromirror Array Lens) including transmission type pattern generating focus-controlled illumination by variable focus optical element (Micromirror Array Lens);

FIG. 7 shows schematic configuration of three dimensional imaging system with variable focus optical element (Micromirror Array Lens) including reflective type pattern generating focus-controlled illumination by variable focus optical element (Micromirror Array Lens);

FIG. 8 shows schematic configuration of three dimensional imaging system with variable focus optical element (Micromirror Array Lens) including pattern generating focus-controlled illumination by variable focus optical element (Micromirror Array Lens) and scanning mirror for field of view control;

FIG. 9 shows schematic configuration of three dimensional imaging system with variable focus optical element (Micromirror Array Lens) including pattern generating focus-controlled illumination by variable focus optical element (Micromirror Array Lens), scanning mirror for field of view control, and extra illumination sources;

FIG. 10 shows schematic configuration of three dimensional imaging system with non-axis symmetric variable focus optical element (Micromirror Array Lens) including pattern generating focus-controlled illumination by variable focus optical element (Micromirror Array Lens), and scanning mirror for field of view control;

FIG. 11 shows apparatus design of three dimensional imaging system with variable focus optical element (Micromirror Array Lens) including pattern generating focus-controlled illumination by variable focus optical element (Micromirror Array Lens);

FIG. 12 shows an example of pattern for three dimensional imaging system with variable focus optical element (Micromirror Array Lens) generated by focus-controlled illumination by variable focus optical element (Micromirror Array Lens);

FIG. 13 shows second example of pattern for three dimensional imaging system with variable focus optical element (Micromirror Array Lens) generated by focus-controlled illumination by variable focus optical element (Micromirror Array Lens), inverted image of FIG. 12;

FIG. 14 shows image taken by the three dimensional imaging system with variable focus optical element (Micromirror Array Lens) and focus-controlled illumination by variable focus optical element (Micromirror Array Lens) by using pattern from FIG. 12;

FIG. 15 shows image taken by the three dimensional imaging system with variable focus optical element (Micromirror Array Lens) and focus-controlled illumination by variable focus optical element (Micromirror Array Lens) by using pattern from FIG. 13;

FIG. 16 shows an AIF (all in focused) image from the three dimensional imaging system generated by using images of FIG. 14 and FIG. 15;

FIG. 17 shows a contour plot of depth-map from the three dimensional imaging system generated by using images of FIG. 14 and FIG. 15;

FIG. 18 shows a three dimensional reconstructed image of the object by the three dimensional imaging system with focus controlled illumination by using images of FIG. 16 and FIG. 17;

FIG. 19 shows a three dimensional reconstructed image with depth map color of the object by the three dimensional imaging system with focus controlled illumination by using images of FIG. 16 and FIG. 17;

### DETAILED DESCRIPTION OF THE ILLUSTRATED EMBODIMENTS

The present invention of three dimensional imaging with variable focus optical element by use of depth from focus technique. Depth from focus technique of the present invention is enhanced by use of focus controlled illumination. In the prior art section, many three dimensional imaging techniques were described. Each technology has its own advantages and disadvantages.

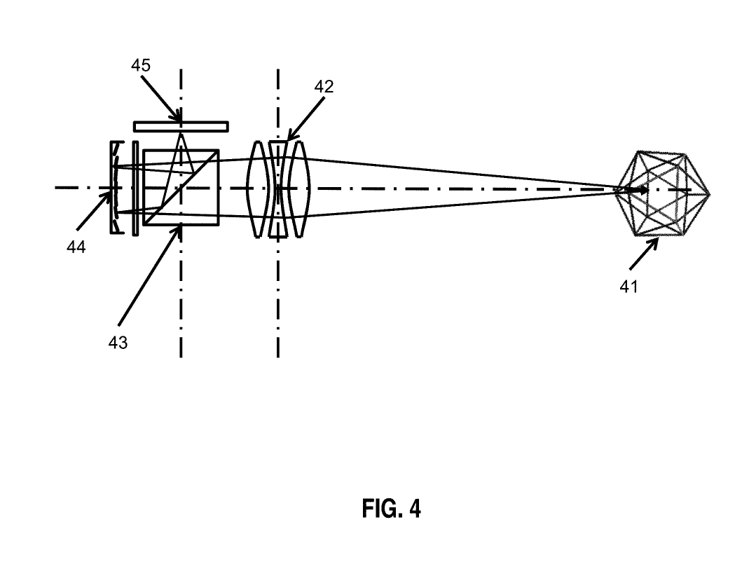

FIG. 4 shows configuration of three dimensional imaging system with variable focus optical element 44 (Micromirror Array Lens). Since the Micromirror Array Lens 44 is a reflective type lens, a beam splitter 43 is used for maintaining axis symmetry of the optical system. Preferably a polarizing beam splitter 43 and waveplate is used to maintain axis symmetry to have higher light efficiency. Without polarization optics, light efficiency becomes half as the light transmits through or reflects from the beam splitter surface. The light from the object 41 is focused through imaging optics 42 and passes through the polarization beam splitter 43. Then the light is reflected from the Micromirror Array Lens 44 and the Micromirror Array Lens 44 changes focal plane of the imaged sensor 45. Based on object distances of the object 41, the Micromirror Array Lens 44 changes its imaging plane by changing its optical power. Then the three dimensional imaging system using the Micromirror Array Lens 44 takes its advantages of the Micromirror Array Lens 44 which has good repeatability and reliability with operation. Thanks to the superior reliability and repeatability of the Micromirror Array Lens 44, the three dimensional depth information of the object plane can be easily converted from the curvature of the Micromirror Array Lens 44 with pre-determined focal length of the Micromirror Array Lens. The three dimensional imaging system scans the depth of the object while varying the focal length of the variable focus system (the Micromirror Array Lens). Only focal length matched parts of the image have a good contrast when the object and image planes are in focus. Using this property, object distance from the optical system can be determined by changing focal length of the variable focus system (the Micromirror Array Lens).

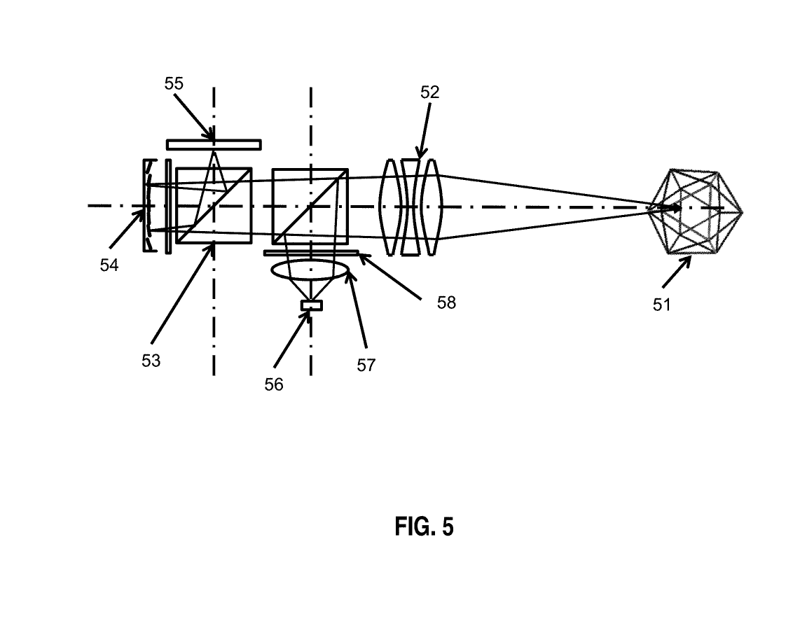

FIG. 5 shows another configuration of the three dimensional imaging system with variable focus optical element 54 (Micromirror Array Lens) including co-axial pattern generating illumination system. For illumination, light is generated from the light source 56. LED (light emitting diode) or LD (laser diode) can be good candidate for the light source 56. Generated light by the light source is collimated through the collimation lens 57 and the light is filtered by the spatial light modulator 58 to generate patterned illumination on the object 51. Imaging lens 52 is also acting as projection lens for the illumination on the object 51. The reflected light is then imaged through the imaging lens 52 and the variable focus optical element 54 (the Micromirror Array Lens). The polarization beam splitter 53 and waveplate are used to improve light efficiency of the system. Finally based on the object distance of the system and the focal length of the variable focus optical element 54 (the Micromirror Array Lens), the light makes image on to the image sensor 55. Focal length of the variable focus optical element 54 (the Micromirror Array Lens) and the contrast of the images determine the object distance of the object 51. The determined object distance and the two dimensional image with highest contrast (which is in focus) make three dimensional information which consists of two dimensional in-focus image and depth information.

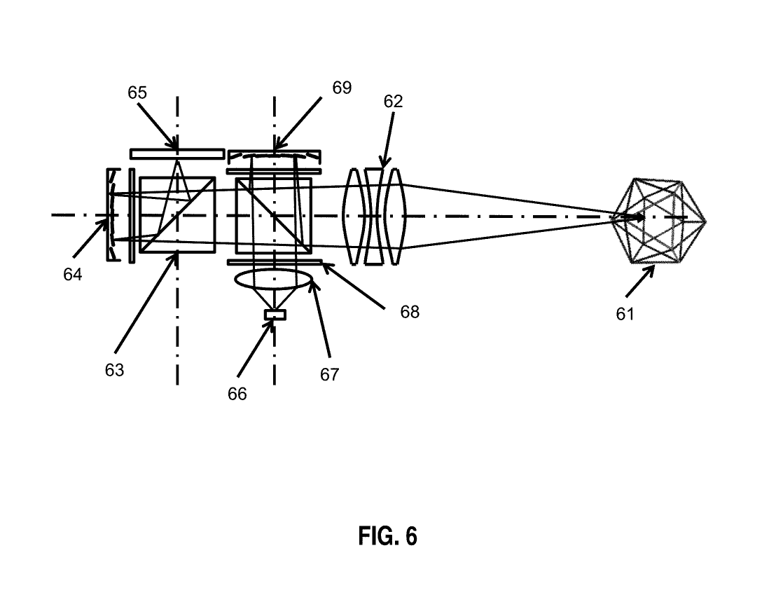

FIG. 6 shows configuration of the three dimensional imaging system with variable focus optical element 64 (Micromirror Array Lens) including focus controlled pattern generating illumination system by variable focus optical element 69 (Micromirror Array Lens) and further including transmission type of pattern generating means (light source 66, collimating lens 67, reflective light modulator 68). For illumination, light is generated from a light source 66. LED (light emitting diode) or LD (laser diode) can be a good candidate for the light source 66. Generated light by the light source 66 is then collimated through the collimation lens 67 and the light is filtered by the spatial light modulator 68 (which is transmission type here) to generate patterned illumination on the object 61. For this pattern generation, stationary pattern can be used like a chrome mask. Also this stationary mask can be moved with time for proper illumination pattern. In more advanced ways, this stationary pattern can be implemented on a disk like a Nipkow disk in confocal microscopy system or an optical chopper for laser experiments or can be moved on a cam structure to be coupled with linear motion. This stationary mask which is not controlled electronically can be moved by a mechanical mean to change pattern shape in time. Time varying pattern change is coupled with imaging side to control focus of the illumination and imaging altogether. Another method is using light modulator to generate pattern actively. LCD (liquid crystal display) or LCOS (liquid crystal on silicon) is a good candidate but any kind of the light modulator can be used here. Before the illumination shine onto the object 61, the focus of the illumination is controlled by a variable focus optical element 69 (Micromirror Array Lens). The focus control of the illumination pattern enhances the contrast of the image of the object 61 onto the image plane at the image sensor 65. For imaging the illumination light source, imaging optics 62 is used. The illumination light from the illumination source then focused onto certain depth of the object 61 which is controlled together with imaging optics, especially with variable focus optical element 64 (Micromirror Array Lens). The reflection from the object 61 is then refocused by the imaging optics 62 and passes through the polarization beam splitter 63 (or beam splitter). And the light is then finally focused based on the object distance by the variable focus optical element 64 (Micromirror Array Lens). The polarization beam splitter 63 and waveplate are used to improve light efficiency of the system. Finally based on the object distance of the system and the focal length of the variable focus optical element 64 (the Micromirror Array Lens), the light makes image on to the image sensor 65. Focal length of the variable focus optical element 64 (the Micromirror Array Lens) and the contrast of the images determine the object distance of the object 61. The determined object distance and the two dimensional image with highest contrast (which is in focus) make three dimensional information which consists of two dimensional in-focus image and depth information.

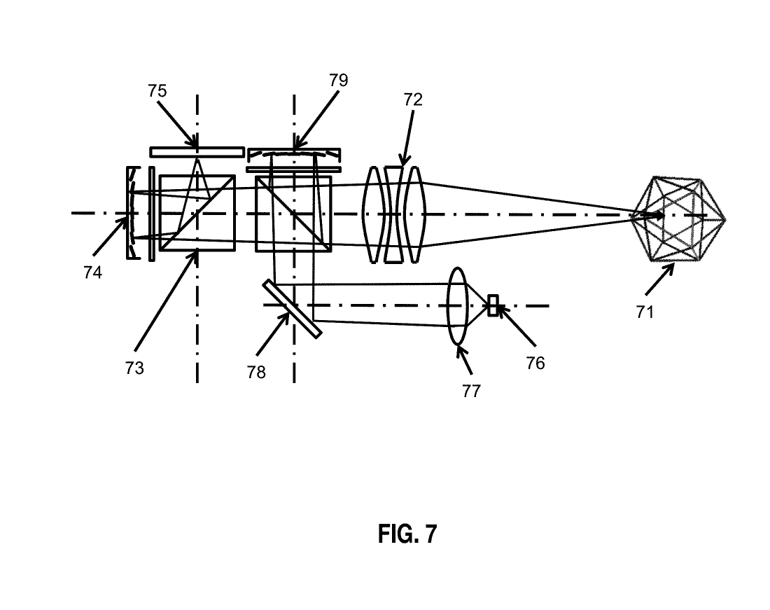

FIG. 7 shows configuration of the three dimensional imaging system with variable focus optical element 74 (Micromirror Array Lens) including focus controlled pattern generating illumination system by variable focus optical element 79 (Micromirror Array Lens) and further including reflective type of pattern generating means (light source 76, collimating lens 77, reflective light modulator 78). For illumination, light is generated from a light source 76. LED (light emitting diode) or LD (laser diode) can be a good candidate for the light source 76. Generated light by the light source 76 is then collimated through the collimation lens 77 and the light is modulated by the spatial light modulator 78 (which is reflection type here) to generate patterned illumination on the object 71. For this pattern generation, stationary pattern can be used like a chrome mask. Also this stationary mask can be moved with time for proper illumination pattern. In more advanced ways, this stationary pattern can be implemented on a disk like a Nipkow disk in confocal microscopy system or an optical chopper for laser experiments or can be moved on a cam structure to be coupled with linear motion. This stationary mask which is not controlled electronically can be moved by a mechanical mean to change pattern shape in time. Time varying pattern change is coupled with imaging side to control focus of the illumination and imaging altogether. Another method is using light modulator to generate pattern actively. DMD (digital micromirror device) or LCOS (liquid crystal on silicon) is a good candidate but any kind of the light modulator can be used here. Before the illumination shine onto the object 71, the focus of the illumination is controlled by a variable focus optical element 79 (Micromirror Array Lens). The focus control of the illumination pattern enhances the contrast of the image of the object 71 onto the image plane at the image sensor 75. For imaging the illumination light source, imaging optics 72 is used. The illumination light from the illumination source then focused onto certain depth of the object 71 which is controlled together with imaging optics, especially with variable focus optical element 74 (Micromirror Array Lens). The reflection from the object 71 is then refocused by the imaging optics 72 and passes through the polarization beam splitter 73 (or beam splitter). And the light is then finally focused based on the object distance by the variable focus optical element 74 (Micromirror Array Lens). The polarization beam splitter 73 and waveplate are used to improve light efficiency of the system. Finally based on the object distance of the system and the focal length of the variable focus optical element 74 (the Micromirror Array Lens), the light makes image on to the image sensor 75. Focal length of the variable focus optical element 74 (the Micromirror Array Lens) and the contrast of the images determine the object distance of the object 71. The determined object distance and the two dimensional image with highest contrast (which is in focus) make three dimensional information which consists of two dimensional in-focus image and depth information.

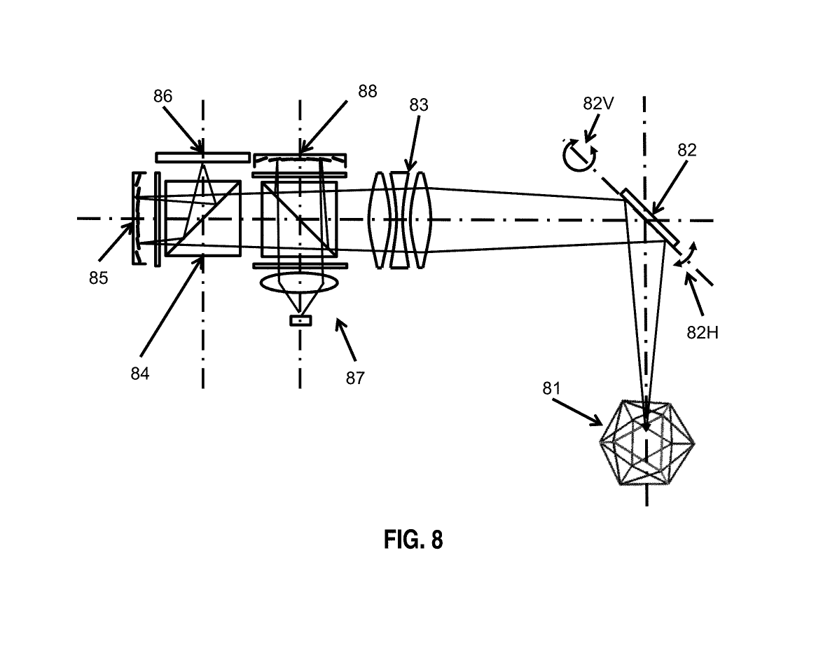

FIG. 8 shows configuration of the three dimensional imaging system with variable focus optical element 85 (Micromirror Array Lens) including focus controlled pattern generating illumination system by variable focus optical element 88 (Micromirror Array Lens) and further including transmission type of pattern generating means 87. In this configuration, actively tilting mirror 82 is added to increase FOV (field of view) of the system. The tilting mirror can be independently moved with horizontally 82H and vertically 82V to change FOV horizontally and vertically, which can increase the optical system considerably. Especially for telecentric optics for three dimensional imaging system is preferred configuration since calibration of the depth is easier than diverging or converging system. For this telecentric optics, increasing FOV is difficult due to size of the optics. The tilting mirror can improve FOV especially for this telecentric optical system. Before the illumination shine onto the object 81, the focus of the illumination is controlled by a variable focus optical element 88 (Micromirror Array Lens). The focus control of the illumination pattern enhances the contrast of the image of the object 81 onto the image plane at the image sensor 86. For imaging the illumination light source, imaging optics 83 is used. The illumination light from the illumination source then focused onto certain depth of the object 81 which is controlled together with imaging optics, especially with variable focus optical element 85 (Micromirror Array Lens). The reflection from the object 81 is then refocused by the imaging optics 83 and passes through the polarization beam splitter 84 (or beam splitter). And the light is then finally focused based on the object distance by the variable focus optical element 85 (Micromirror Array Lens). The polarization beam splitter 84 and waveplate are used to improve light efficiency of the system. Finally based on the object distance of the system and the focal length of the variable focus optical element 85 (the Micromirror Array Lens), the light makes image on to the image sensor 86. Focal length of the variable focus optical element 85 (the Micromirror Array Lens) and the contrast of the images determine the object distance of the object 81. The determined object distance and the two dimensional image with highest contrast (which is in focus) make three dimensional information which consists of two dimensional in-focus image and depth information.

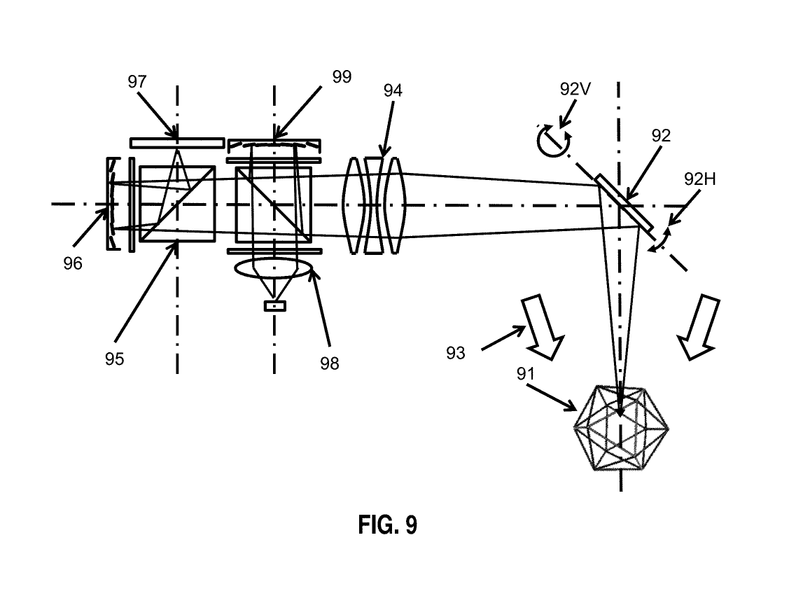

FIG. 9 shows configuration of the three dimensional imaging system with variable focus optical element 96 (Micromirror Array Lens) including focus controlled pattern generating illumination system by variable focus optical element 99 (Micromirror Array Lens) and further including transmission type of pattern generating means 98. In this configuration, actively tilting mirror 92 is added to increase FOV (field of view) of the system as well as extra illumination system 93 for better imaging. The tilting mirror can be independently moved with horizontally 92H and vertically 92V to change FOV horizontally and vertically, which can increase the optical system considerably. Especially for telecentric optics for three dimensional imaging system is preferred configuration since calibration of the depth is easier than diverging or converging system. For this telecentric optics, increasing FOV is difficult due to size of the optics. The tilting mirror can improve FOV especially for this telecentric optical system. Before the illumination shine onto the object 91, the focus of the illumination is controlled by a variable focus optical element 99 (Micromirror Array Lens). The focus control of the illumination pattern enhances the contrast of the image of the object 91 onto the image plane at the image sensor 97. For imaging the illumination light source, imaging optics 94 is used. The illumination light from the illumination source then focused onto certain depth of the object 91 which is controlled together with imaging optics, especially with variable focus optical element 96 (Micromirror Array Lens). The reflection from the object 91 is then refocused by the imaging optics 94 and passes through the polarization beam splitter 95 (or beam splitter). And the light is then finally focused based on the object distance by the variable focus optical element 96 (Micromirror Array Lens). The polarization beam splitter 95 and waveplate are used to improve light efficiency of the system. Finally based on the object distance of the system and the focal length of the variable focus optical element 96 (the Micromirror Array Lens), the light makes image on to the image sensor 97. Focal length of the variable focus optical element 96 (the Micromirror Array Lens) and the contrast of the images determine the object distance of the object 91. The determined object distance and the two dimensional image with highest contrast (which is in focus) make three dimensional information which consists of two dimensional in-focus image and depth information.

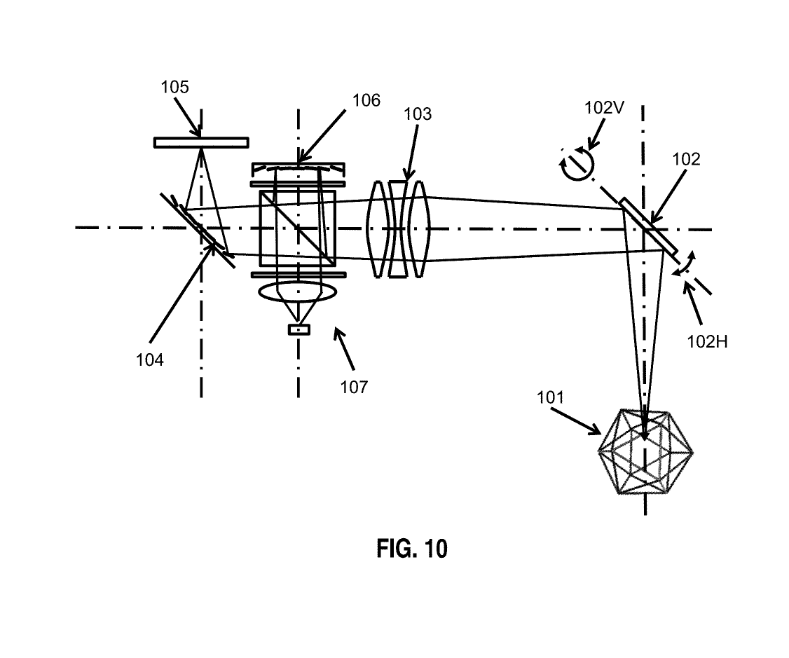

FIG. 10 shows configuration of the three dimensional imaging system with variable focus optical element 104 (Micromirror Array Lens) including focus controlled pattern generating illumination system 107 by variable focus optical element 106 (Micromirror Array Lens) and further including transmission type of pattern generating means. Especially the variable focus optical element 104 (Micromirror Array Lens) is not axis symmetric. With this non-axis symmetric variable focus optical element (Micromirror Array Lens), light efficiency of the system increases since no beam splitter is required to preserve axis symmetry. In this configuration, actively tilting mirror 102 is added to increase FOV (field of view) of the system. The tilting mirror can be independently moved with horizontally 102H and vertically 102V to change FOV horizontally and vertically, which can increase the optical system considerably. Especially for telecentric optics for three dimensional imaging system is preferred configuration since calibration of the depth is easier than diverging or converging system. For this telecentric optics, increasing FOV is difficult due to size of the optics. The tilting mirror can improve FOV especially for this telecentric optical system. Before the illumination shine onto the object 101, the focus of the illumination is controlled by a variable focus optical element 106 (Micromirror Array Lens). The focus control of the illumination pattern enhances the contrast of the image of the object 101 onto the image plane at the image sensor 105. For imaging the illumination light source, imaging optics 103 is used. The illumination light from the illumination source then focused onto certain depth of the object 101 which is controlled together with imaging optics, especially with variable focus optical element 106 (Micromirror Array Lens). The reflection from the object 101 is then refocused by the imaging optics 103. This time this reflection process does not use beam splitter, which increases light efficiency of the system. And the light is then finally focused based on the object distance by the variable focus optical element 104 (Micromirror Array Lens). Finally based on the object distance of the system and the focal length of the variable focus optical element 104 (the Micromirror Array Lens), the light makes image on to the image sensor 105. Focal length of the variable focus optical element 104 (the Micromirror Array Lens) and the contrast of the images determine the object distance of the object 101. The determined object distance and the two dimensional image with highest contrast (which is in focus) make three dimensional information which consists of two dimensional in-focus image and depth information. In this configuration, introducing non axis symmetric variable focus optical element (Micromirror Array Lens) improves light efficiency of the whole optical system.

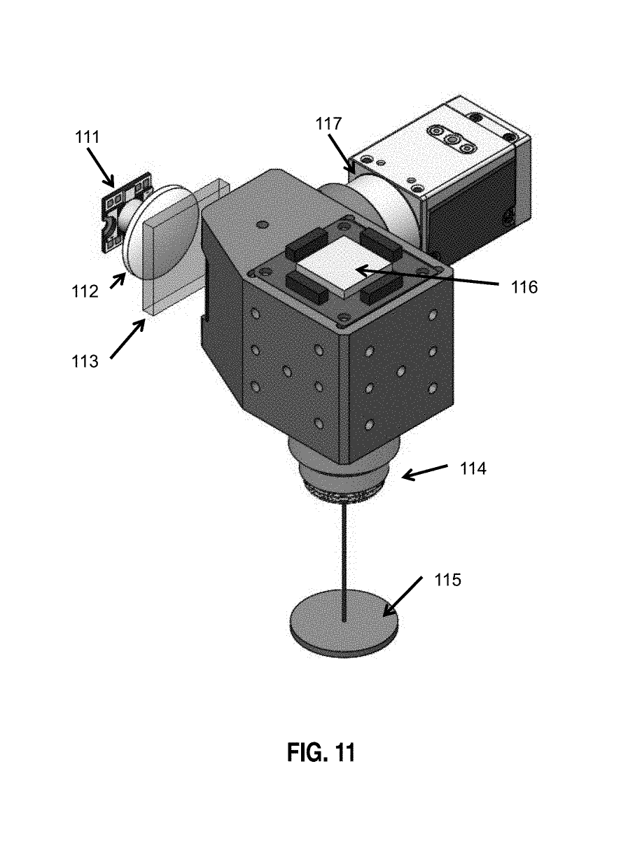

FIG. 11 shows three dimensional modeling of the optical configuration. Light source 111 (in this figure LED is used), collimation lens 112 for light source 111, imaging optics 114, and variable focus optical element 116 (Micromirror Array Lens) and image sensor 117 are shown. Illumination light is generated from a light source 111. LED (light emitting diode) or LD (laser diode) can be a good candidate for the light source 111. Generated light by the light source 111 is then collimated through the collimation lens 112 and the light is modulated by the spatial light modulator 113 (which is reflection type here) to generate patterned illumination on the object 115. For this specific example, transmission LCD display device is used. DMD (digital micromirror device) or LCOS (liquid crystal on silicon) can be used as a reflective type pattern generating means. Before the illumination shine onto the object 115, the focus of the illumination is controlled by a variable focus optical element 116 (Micromirror Array Lens). The focus control of the illumination pattern enhances the contrast of the image of the object 115 onto the image plane at the image sensor 117. For imaging the illumination light source, imaging optics 114 is used. The illumination light from the illumination source then focused onto certain depth of the object 115 which is controlled together with imaging optics, especially with variable focus optical element 116 (Micromirror Array Lens). The reflection from the object 115 is then refocused by the imaging optics 114 and passes through the polarization beam splitter (not shown). And the light is then finally focused based on the object distance by the variable focus optical element 116 (Micromirror Array Lens). The polarization beam splitter and waveplate are used to improve light efficiency of the system. Finally based on the object distance of the system and the focal length of the variable focus optical element 116 (the Micromirror Array Lens), the light makes image on to the image sensor 117. Focal length of the variable focus optical element 116 (the Micromirror Array Lens) and the contrast of the images determine the object distance of the object 115. The determined object distance and the two dimensional image with highest contrast (which is in focus) make three dimensional information which consists of two dimensional in-focus image and depth information.

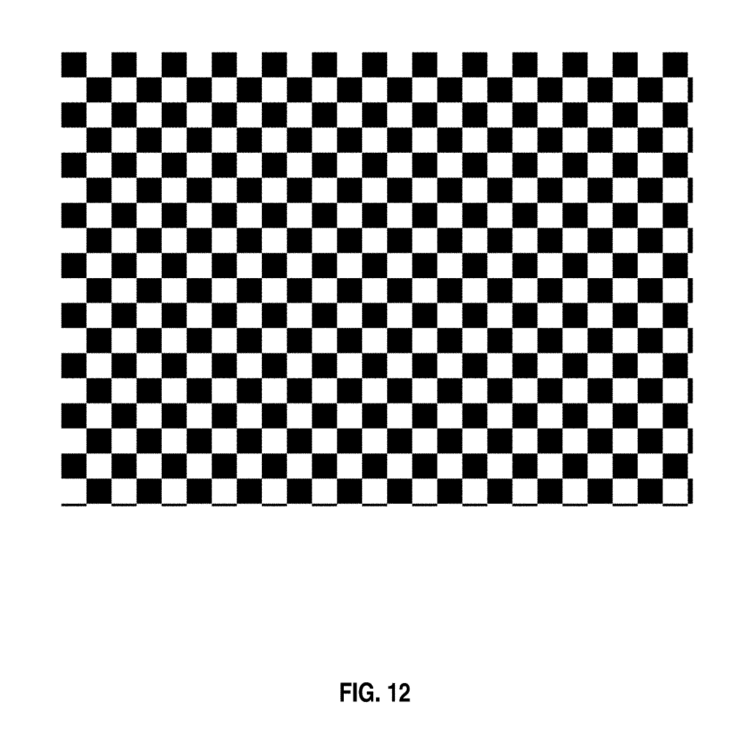

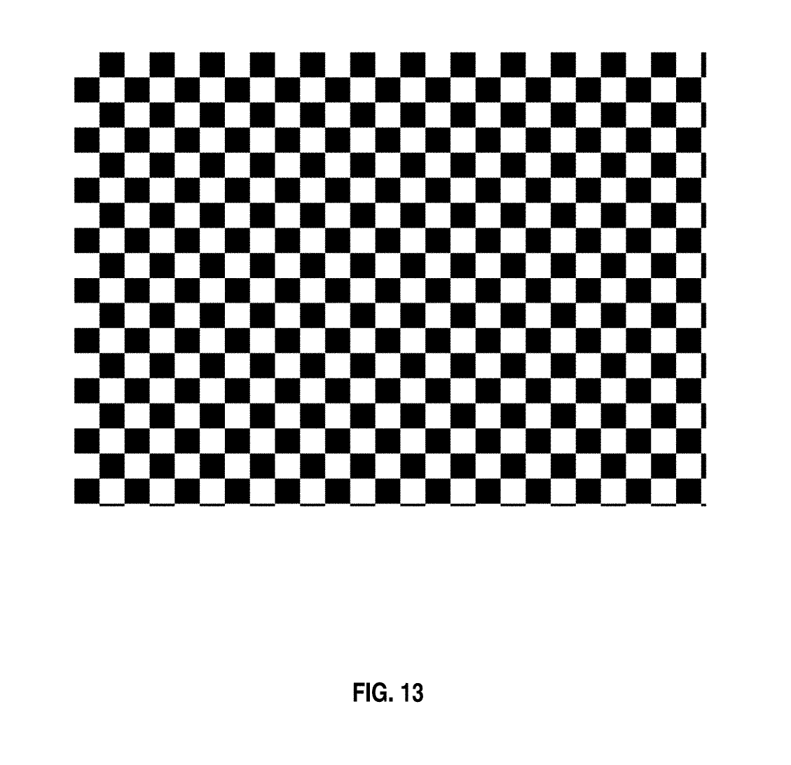

FIG. 12 and FIG. 13 show an example of pattern. In this specific example, checker board mark is used. FIG. 12 and FIG. 13 have exclusive and complimentary pattern. The white area represents illuminated are on the object. In this white area, image of the object can be obtained. Since the present invention is using contrast of the object images, the edges between white and black pattern is important. With the edge contrast of the black and white border, contrast of the image could be enhanced independently with the object properties such as the surface quality, texture of the object surface, illumination condition, reflectivity of the object surface and so on. With this edge contrast, the depth of the object can be calculated. The finer the pattern is the higher resolution of the depth information can be obtained. To enhance more, phase shifting interferometric algorithm can be used. For phase shifting interferometric algorithm, more illumination patterns are required. For this phase shifting interferometric algorithm, coarse and fine illumination patterns can be introduced for range and resolution purpose respectively. Other illumination patterns can be used such as stripes, concentric circles, point array, stripes with varying period and so on.

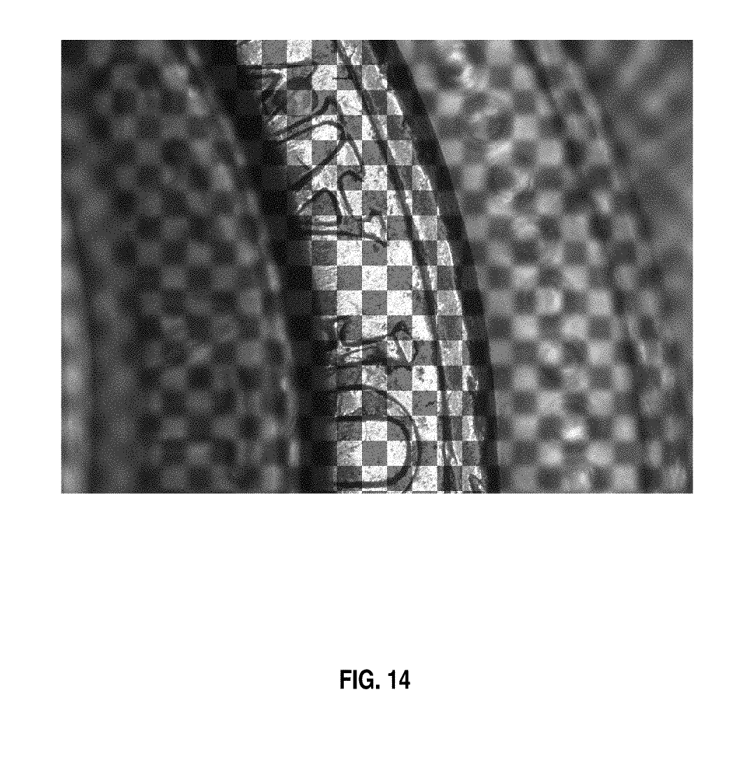

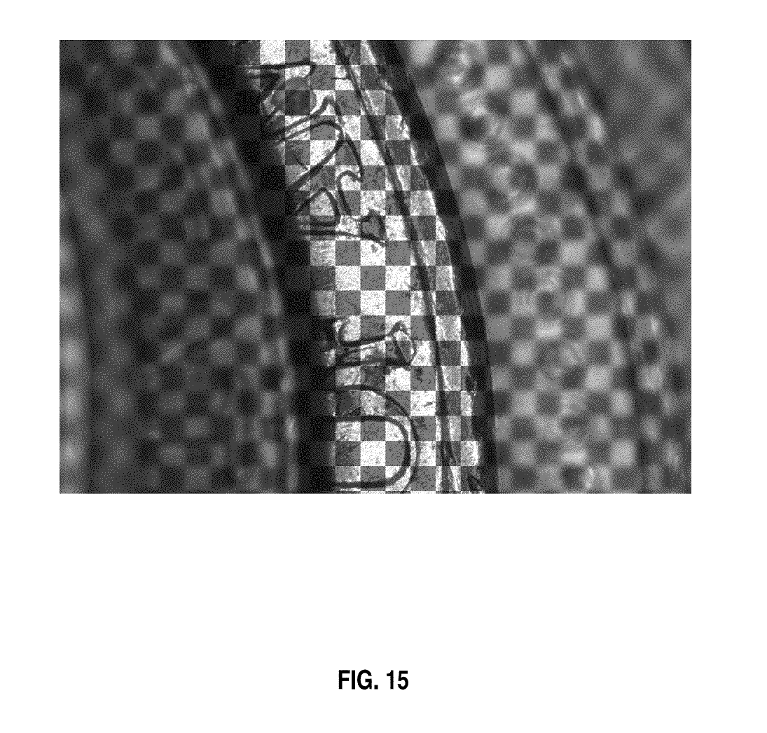

FIG. 14 and FIG. 15 are captured images based on pattern illumination from FIG. 12 and FIG. 13. Illumination patterns are focus controlled in the middle of images (white coin). As can be seen, on the white coin patterns have clear contrast and at the off-focus positions (other coins), poor contrast is obtained. When the image itself does not have a good contrast, illumination pattern border can be used to extract the good contrast point of the image. With this technique, all the area of the images can have high contrast, which enhances depth from focus algorithm performance. With this method, difficulties finding depth in algorithm could be solved. Especially, surface irregularity, angled surface problems can be solved.

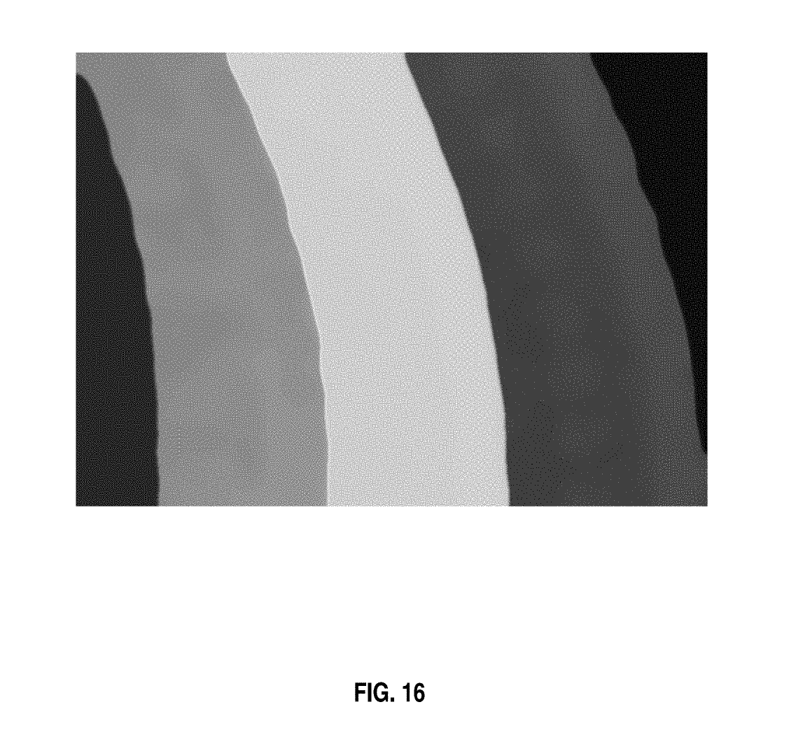

FIG. 16 shows depth map image of the objects. With this color images, clearly depth of the images can be resolved. Due to surface irregularity, some points could have been miscalculated with three dimensional calculation algorithm. But by using focus controlled illumination method, all the image areas can have its own height with high contrast from the images. With this height and in-focused images from the above, all-in-focus image can be reconstructed.

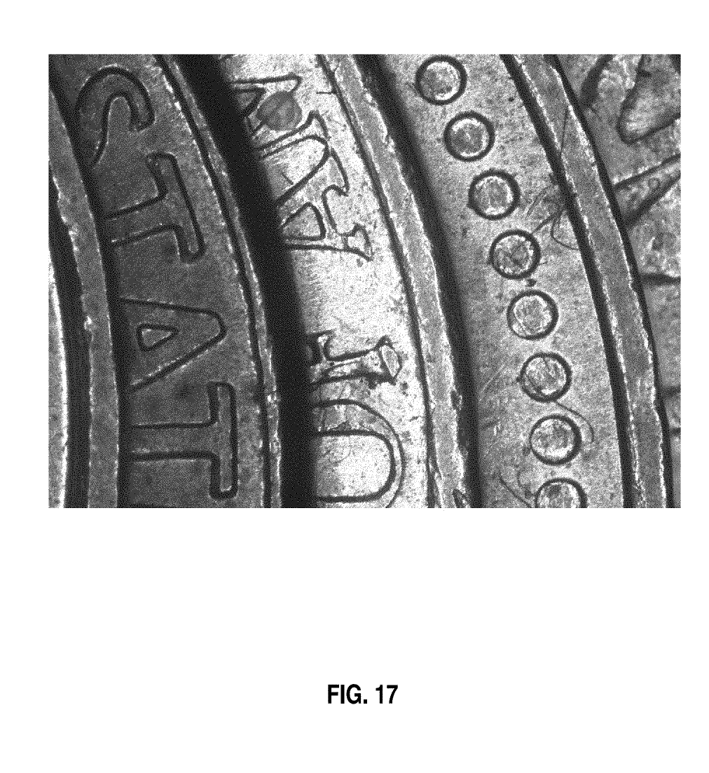

FIG. 17 shows all-in-focus image of the objects. From the depth image of FIG. 16, each pixel can be obtained from the images depth-corresponded from the depth map each pixel. Thus each pixel is differently taken from depth-dependent images by using the depth information from the depth map which was taken in FIG. 16. As clearly can be seen in FIG. 17, all the images are clearly in focused. From this all-in-focus image in FIG. 17 and depth map in FIG. 16, three dimensional image can be easily reconstructed. While taking pixel images in x, y dimension from all-in-focus image, depth information can be taken from depth map. Thus x, y information plus depth information form a three dimensional reconstructed image.

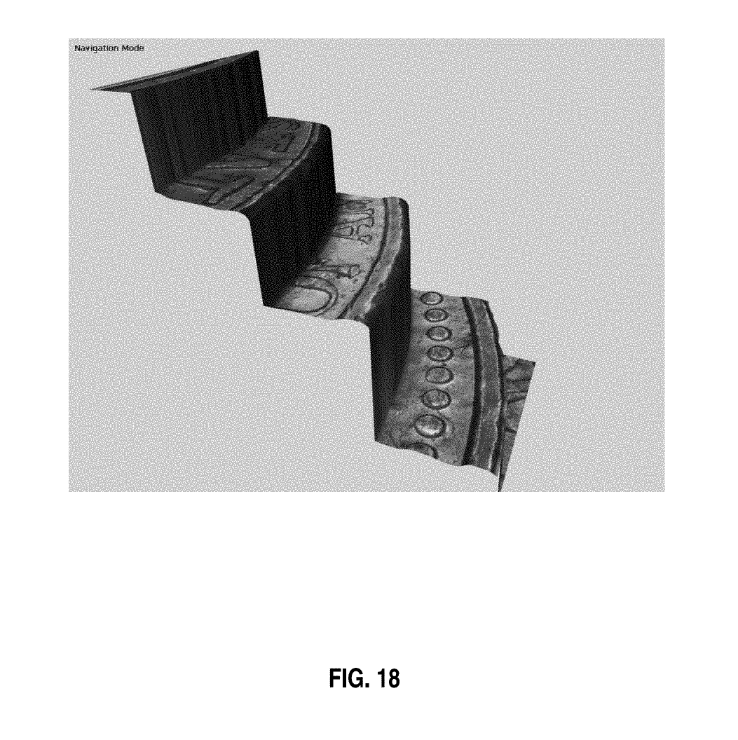

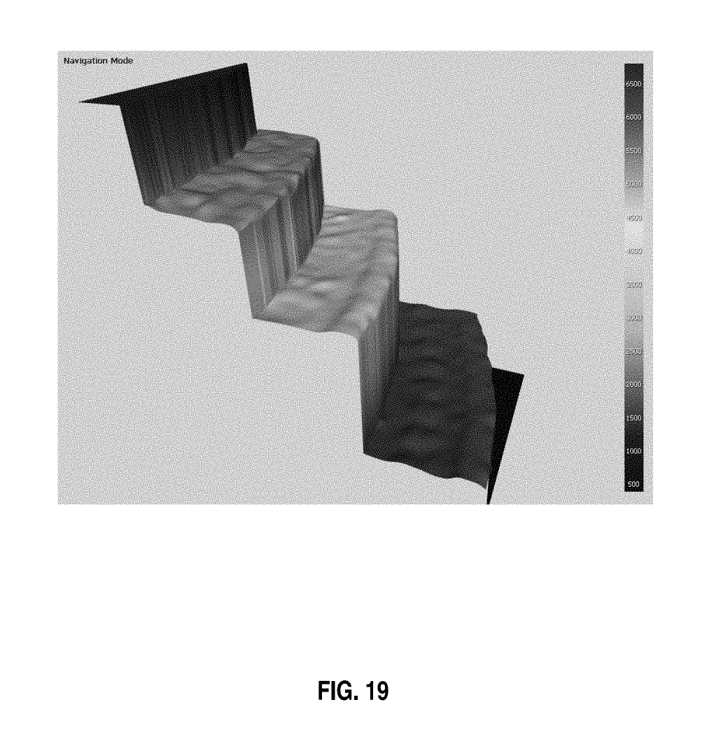

FIG. 18 shows three dimensional reconstructed image by using all-in-focus image from FIG. 17 and depth map image from FIG. 16. Each corresponding pixel gives three dimensional information of the object, all-in-focus image gives x, y information and depth map gives z (depth) information. With these data, three dimensional information was recomposed and three dimensional image is reconstructed. Views are rotated to give a clear contrast of three dimensional information. In FIG. 19, the same three dimensional reconstructed image was shown with color depth map. Color difference gives depth information also to clearly shows depth information.

The present invention of an enhanced three dimensional imaging system with focus controlled illumination comprises an illumination source with focus control wherein the illumination source comprises a variable focus optical element for illumination focus control, an imaging optics for the three dimensional imaging system, a beam combining mean wherein the beam combining mean combines illumination and imaging light, a variable focus optical element wherein the variable focus optical element changes focal planes of the imaging system and a photosensitive optical sensor device wherein the optical sensor takes area images. And the variable focus optical elements scan objects in optical depth dimension to get three dimensional images.

The variable focus optical element in the illumination source with focus control of the present invention comprises an actively controlled variable focus optical element for focus control of the illumination. This actively controlled variable focus optical element can change focal plane of the object without disturbing image plane while image plane is maintained onto the image sensor.

The variable focus optical element in the illumination source with focus control of the present invention comprises a passively controlled variable optical element for focus control of the illumination, wherein the passively controlled variable optical element is coupled with the variable focus optical element for changing focal plane of the imaging system. This passively controlled variable focus optical element changes focal plane of the illumination light onto the object while the passively controlled variable focus element changes focal plane based on the change of the. And the focus of the illumination can be controlled together with imaging to be in-focused through the three dimensional scan.

The illumination source with focus control of the present invention comprises a pattern generating mean wherein the pattern generating mean provides high contrast image of the objects for three dimensional image reconstruction process wherein the contrast of the image is improved through the focus of the generated pattern. The pattern generating mean comprises a light blocking pattern mask. With this hard mask, the pattern generating mean can form a pre-designed illumination pattern. For this light blocking mask in the pattern generating mean, chrome mask can be a good candidate for fine structured pattern generation. The light blocking pattern mask in the pattern generating mean can move coupled with focus control of the illumination source with focus control. With this movement, the light blocking pattern mask in the pattern generating mean can generate multiple pattern or can generate illumination patter for all the area.

The pattern generating mean of the present invention can further comprise a spatial light modulator (SLM) wherein the spatial light modulator generates patterns for the illumination source with focus control. With the spatial light modulator, dynamic pattern can be generated and cover all the area of the images. The spatial light modulator of the present invention can use a reflection type such as a digital micromirror device (DMD) and a liquid crystal on silicon device (LCOS). For use this reflective type spatial light modulator, optical arrangement can be like one in FIG. 7.

While a reflection type spatial light modulator can be used, a transmission type spatial light modulator can also be used. The spatial light modulator of the present invention can be a transmission type such as liquid crystal display (LCD). The illumination source with focus control in the present invention comprises a light source with the pattern generating mean such as organic light emitting diode display (OLED), wherein the light source with patter generating mean generates patterns with turning on and off area control.

The imaging optics of the present invention shares optical path with the illumination source with focus control. To optimize size and compactness of the system, basic optics for imaging and illumination can be shared. To change focal plane of the object while maintaining the image plane, the variable focus optical element of the present invention comprises a variable focus lens. The variable focus optical element of the present invention comprises a variable focus mirror. As well as transmission type variable optical element, reflective type variable optical element can be used with simple geometry change. The variable focus optical element of the present invention comprises a Micromirror Array Lens. The variable focus optical element varies base optical power of the three dimensional imaging system. Sometimes, optical power variation is not enough for the variable focus optical element itself. For this case, base optical power is set by the imaging optics or illumination optics and the variable focus optical element applies only variation of the optical power.

The photosensitive optical sensor device of the present invention comprises a line scan camera wherein the line scan camera takes multiple images for images of area of interest. The photosensitive optical sensor device of the present invention can also comprise an area scan camera wherein the area scan camera takes multiple images for images of area of interest.

The present invention discloses a method for three dimensional image taking with focus controlled illumination comprising determining base optical power of the three dimensional imaging system based on objects (an object) to be imaged, changing focal plane of the variable focus optical element, wherein the variable focus optical element changes focal plane of the imaging system for depth scan of the objects, controlling focus of an illumination source with focus control wherein the focus of the illumination source is coupled with the focal plane of the imaging system, taking images based on the focal plane of the variable focus optical element, wherein the taken images are processed to extract three dimensional information of the objects.

The illumination source of the present invention of the three dimensional image taking with focus controlled illumination has a pattern generating mean. The pattern generating mean of the present invention comprises a variable focus optical element, wherein the variable focus optical element controls the focus of the illumination source.

The variable focus optical element of the present invention can be a Micromirror Array Lens. The variable focus optical element of the present invention varies base optical power of the three dimensional imaging system. The variable focus optical element of the present invention comprises a variable focus lens. The variable focus optical element of the present invention comprises a variable focus mirror. The variable focus optical element comprises a Micromirror Array Lens, wherein the Micromirror Array Lens satisfies phase matching condition and convergence condition.

The method for three dimensional image taking with focus controlled illumination of the present invention further comprises changing optical parameters of the system. The optical parameters of the present invention are illumination condition, exposure time, numerical aperture or focal distance of the imaging system.

Even though the property of the Micromirror Array Lens is briefly disclosed in the present invention, the detail about the Micromirror Array Lens is disclosed in the following patents. The general principle and methods for making the Micromirror Array Lens are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,619,807 issued Nov. 17, 2009 to Baek, and U.S. Pat. No. 7,777,959 issued Aug. 17, 2010 to Sohn, all of which are incorporated herein by references.

The general principle, structure and methods for making the micromirror array devices and Micromirror Array Lens are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim, U.S. Pat. No. 7,777,959 issued Aug. 17, 2010 to Sohn, U.S. Pat. No. 7,898,144 issued Mar. 1, 2011 to Seo, U.S. Pat. No. 8,687,276 issued Apr. 1, 2014 to Cho, U.S. Pat. No. 9,505,606 issued Nov. 29, 2016 to Sohn, and U.S. Pat. Pub. No 2009/0303569 published Dec. 10, 2009, all of which are incorporated herein by references.

The general properties of the Micromirror Array Lens are disclosed in U.S. Pat. No. 7,173,653 issued Feb. 6, 2007 to Gim, U.S. Pat. No. 7,215,882 issued May 8, 2007 to Cho, U.S. Pat. No. 7,236,289 issued Jun. 26, 2007 to Baek, U.S. Pat. No. 7,354,167 issued Apr. 8, 2008 to Cho, U.S. Pat. No. 9,565,340 issued Feb. 7, 20017 to Seo, U.S. Pat. No. 9,736,346 issued Aug. 15, 2017 to Baek, all of which are incorporated herein by references.

The general principle, methods for making the micromirror array devices and Micromirror Array Lens, and their applications are disclosed in U.S. Pat. No. 7,057,826 issued Jun. 6, 2006 to Cho, U.S. Pat. No. 7,068,416 issued Jun. 27, 2006 to Gim, U.S. Pat. No. 7,077,523 issued Jul. 18, 2006 to Seo, U.S. Pat. No. 7,212,330 issued May 1, 2007 to Seo, U.S. Pat. No. 7,261,417 issued Aug. 28, 2007 to Cho, U.S. Pat. No. 7,315,503 issued Jan. 1, 2008 to Cho, U.S. Pat. No. 7,333,260 issued Feb. 19, 2008 to Cho, U.S. Pat. No. 7,339,746 issued Mar. 4, 2008 to Kim, U.S. Pat. No. 7,350,922 issued Apr. 1, 2008 to Seo, U.S. Pat. No. 7,410,266 issued Aug. 12, 2008 to Seo, U.S. Pat. No. 7,580,178 issued Aug. 25, 2009 to Cho, U.S. Pat. No. 7,605,989 issued Oct. 20, 2009 to Sohn, U.S. Pat. No. 7,619,614 issued Nov. 17, 2009 to Baek, U.S. Pat. No. 7,667,896 issued Feb. 23, 2010 to Seo, U.S. Pat. No. 7,742,232 issued Jun. 22, 2010 to Cho, U.S. Pat. No. 7,751,694 issued Jul. 6, 2010 to Cho, U.S. Pat. No. 7,768,571 issued Aug. 3, 2010 to Kim, U.S. Pat. No. 8,049,776 issued Nov. 1, 2011 to Cho, U.S. Pat. No. 8,345,146 issued Jan. 1, 2013 to Cho, U.S. Pat. No. 8,622,557 issued Jan. 7, 2014 to Cho, U.S. Pat. No. 8,810,908 issued Aug. 19, 2014 to Kim, U.S. Pat. Pub. No. 2006/0203117 published Sep. 14, 2006, U.S. Pat. Pub. No. 2007/0041077 published Feb. 22, 2007, U.S. Pat. Pub. No. 2007/0040924 published Feb. 22, 2007, U.S. Pat. Pub. No. 2009/0185067 published Jul. 23, 2009, U.S. Pat. Pub. No. 2012/0133761 published May 31, 2012, and U.S. patent application Ser. No. 15/333,188 filed Oct. 25, 2016, all of which are incorporated herein by references.

The general principle, structure and methods for making the discrete motion control of MEMS device are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim, U.S. Pat. No. 7,777,959 issued Aug. 17, 2010 to Sohn, U.S. Pat. No. 7,898,144 issued Mar. 1, 2011 to Seo, and U.S. Pat. No. 9,505,606 issued Nov. 29, 2016 to Sohn, all of which are incorporated herein by references.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. An enhanced three dimensional imaging system with focus controlled illumination comprising:
a. an illumination source with focus control;
b. an imaging optics wherein the imaging optics determines base optical power of the three dimensional imaging system;
c. a variable focus optical element wherein the variable focus optical element changes focal plane of the imaging system; and
d. a photosensitive optical sensor device wherein the optical sensor takes area images;
wherein said variable focus optical element scans objects in optical depth dimension to get three dimensional images.

2. The enhanced three dimensional imaging system with focus controlled illumination in claim 1, wherein the illumination source with focus control comprises an actively controlled variable focus optical element for focus control of the illumination.

3. The enhanced three dimensional imaging system with focus controlled illumination in claim 1, wherein the illumination source with focus control comprises a passively controlled variable optical element for focus control of the illumination, wherein the passively controlled variable optical element is coupled with the variable focus optical element for changing focal plane of the imaging system.

4. The enhanced three dimensional imaging system with focus controlled illumination in claim 1, wherein the illumination source with focus control comprises a light generating mean and a collimating mean to optically match collimation with imaging system.

5. The enhanced three dimensional imaging system with focus controlled illumination in claim 1, wherein the illumination source with focus control comprises a pattern generating mean wherein the pattern generating mean provides high contrast image of the objects for three dimensional image reconstruction process wherein the contrast of the image is improved through the focus of the generated pattern.

6. The enhanced three dimensional imaging system with focus controlled illumination in claim 5, wherein the pattern generating mean comprises a light blocking pattern mask.

7. The enhanced three dimensional imaging system with focus controlled illumination in claim 6, wherein the light blocking pattern mask moves coupled with focus control of the illumination source with focus control.

8. The enhanced three dimensional imaging system with focus controlled illumination in claim 5, wherein the pattern generating mean comprise a spatial light modulator (SLM) wherein the spatial light modulator generates patterns for the illumination source with focus control.

9. The enhanced three dimensional imaging system with focus controlled illumination in claim 8, wherein the spatial light modulator is a reflection type such as a digital micromirror device (DMD) and a liquid crystal on silicon device (LCOS).

10. The enhanced three dimensional imaging system with focus controlled illumination in claim 9, wherein the spatial light modulator is a transmission type such as liquid crystal display (LCD).

11. The enhanced three dimensional imaging system with focus controlled illumination in claim 1, wherein the illumination source with focus control comprises a light source with pattern generating mean such as organic light emitting diode display (OLED), wherein the light source with patter generating mean generates patterns with turning on and off area control.

12. The enhanced three dimensional imaging system with focus controlled illumination in claim 1, wherein the imaging optics shares optical path with the illumination source with focus control.

13. The enhanced three dimensional imaging system with focus controlled illumination in claim 1, wherein the variable focus optical element comprises a variable focus lens.

14. The enhanced three dimensional imaging system with focus controlled illumination in claim 1, wherein the variable focus optical element comprises a variable focus mirror.

15. The enhanced three dimensional imaging system with focus controlled illumination in claim 1, wherein the variable focus optical element comprises a Micromirror Array Lens.

16. The enhanced three dimensional imaging system with focus controlled illumination in claim 1, wherein the variable focus optical element varies base optical power of the three dimensional imaging system.

17. The enhanced three dimensional imaging system with focus controlled illumination in claim 1, wherein the photosensitive optical sensor device comprises a line scan camera wherein the line scan camera takes multiple images for images of area of interest.

18. The enhanced three dimensional imaging system with focus controlled illumination in claim 1, wherein the photosensitive optical sensor device comprises an area scan camera wherein the area scan camera takes multiple images for images of area of interest.

19. A method for three dimensional image taking with focus controlled illumination comprising:
a. determining base optical power of the three dimensional imaging system based on objects (an object) to be imaged;
b. changing focal plane of the variable focus optical element, wherein the variable focus optical element changes focal plane of the imaging system for depth scan of the objects;
c. controlling focus of an illumination source with focus control wherein the focus of the illumination source is coupled with the focal plane of the imaging system;
d. taking images based on the focal plane of the variable focus optical element;
wherein the taken images are processed to extract three dimensional information of the objects.

20. The method for three dimensional image taking with focus controlled illumination in claim 19, wherein the illumination source has a pattern generating mean.

21. The method for three dimensional image taking with focus controlled illumination in claim 20, wherein the pattern generating mean comprises a variable focus optical element, wherein the variable focus optical element controls the focus of the illumination source.

22. The method for three dimensional image taking with focus controlled illumination in claim 19, wherein the variable focus optical element is a Micromirror Array Lens.

23. The method for three dimensional image taking with focus controlled illumination in claim 19 further comprises changing optical parameters of the system.

24. The method for three dimensional image taking with focus controlled illumination in claim 23, wherein the optical parameters are illumination condition, exposure time, numerical aperture or focal distance of the imaging system.
